(19) United States
(12) Patent Application Publication
(10) Pub. No.: US 2014/0209579 A1
(43) Pub. Date: Jul. 31, 2014

(54) DEVICE FOR CUTTING SAPPHIRE SUBSTRATE

(71) Applicant: HON HAI PRECISION INDUSTRY CO., LTD., New Taipei (TW)

(72) Inventors: GA-LANE CHEN, Santa Clara, CA (US); CHUNG-PEI WANG, New Taipei (TW)

(73) Assignee: HON HAI PRECISION INDUSTRY CO., LTD., New Taipei (TW)

(21) Appl. No.: 14/014,426

(22) Filed: Aug. 30, 2013

(30) Foreign Application Priority Data
Jan. 25, 2013 (TW) 102102819

(51) Int. Cl. B23K 26/06; B23K 26/38

(52) U.S. Cl. CPC B23K 26/0635; B23K 26/38
USPC 219/121.67

(57) ABSTRACT

A pulse-operated laser emitting device for cutting a sapphire substrate includes a picoseconds laser for emitting a laser beam and a collimator lens positioned in a path of the laser beam and which cuts the sapphire substrate cleanly so as not to require any grinding or polishing processes afterwards.

### BACKGROUND

1. Technical Field

The present disclosure relates to sapphire machining, and particularly to a device to cut a sapphire substrate.

2. Description of Related Art

Sapphires have excellent mechanical and optical properties and therefore are used in electronic devices. For example, the sapphire has high scratch and abrasion resistance and therefore can be used as a cover glass of a lens module or a front cover of a cell phone to protect the lens module or the cell phone from being scratched or abraded. However, as the sapphire has a high hardness (9 Mohs scale), it is difficult to cut the sapphire to obtain desired shapes and sizes. Micro-cracks may be introduced by a cutting process and therefore grinding and polishing processes are required, which decreases efficiency of production.

Therefore, it is desirable to provide a device for cutting sapphire that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a schematic view of a device for cutting a sapphire substrate, according to an embodiment.

FIG. 2 is a schematic view of parts of the device of FIG. 1.

### DETAILED DESCRIPTION

Embodiments of the present disclosure will be described with reference to the drawings.

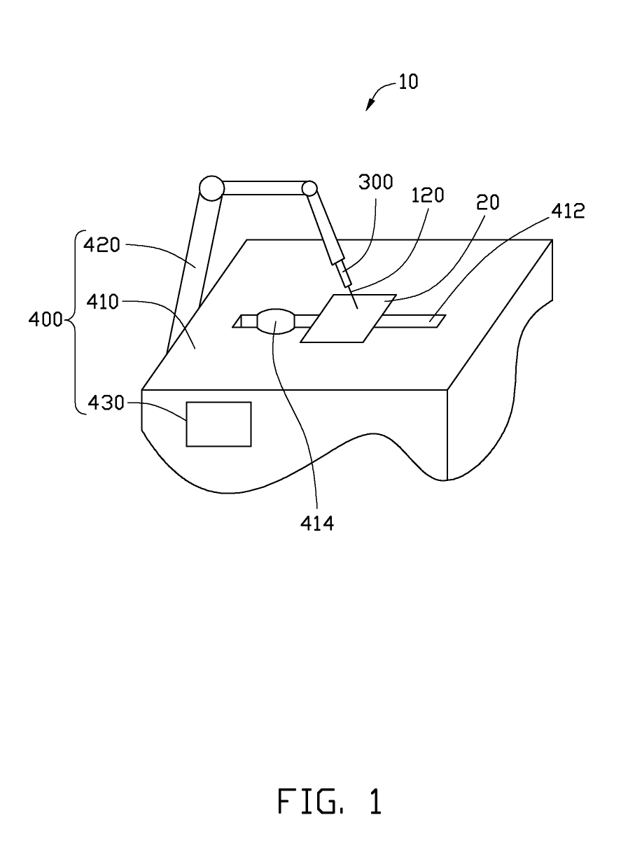

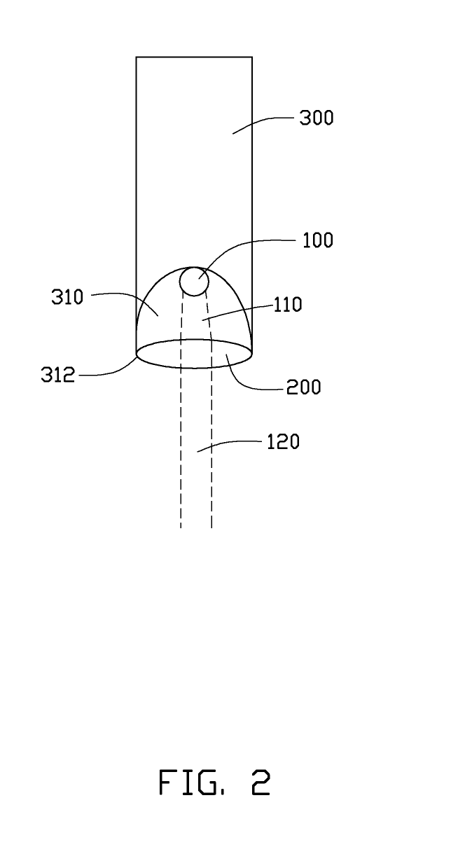

FIGS. 1 and 2 show a device 10 for cutting a sapphire substrate 20, according to an embodiment. The device 10 includes a picoseconds laser 100 and a collimator lens 200. The picoseconds laser 100 emits a laser beam 110 having a pulse width shorter than 15 picoseconds. The collimator lens 200 is positioned in a path of the laser beam 110 to collimate the laser beam 110 to produce a collimated laser beam 120 for cutting the sapphire substrate 20.

The pulse width of the laser beam 110 is short enough to reduce thermal reaction between the laser beam 120 and the sapphire substrate 20. As such, hot-melt problems conventionally happening to a cut surface are avoided and smoothness of the cut surface is improved. As a consequence, grinding and polishing processes are not needed any more and efficiency is increased. In addition, as the picoseconds laser 100 has a higher repetition frequency, as compared with conventional lasers, cutting speed can therefore be increased, further improving the efficiency.

The picoseconds laser 100 can be an ultrasonic, green, or near-infrared laser. A wavelength of the laser beam 110 can be about 355 nm, 343 nm, 266 nm, 532 nm, 515 nm, 1030 nm, or 1064 nm. The repetition frequency of the laser beam 110 can be adjusted.

The device 10 also includes a shell 300. The shell 300 defines a receiving space 310, which has an opening 312. The picoseconds laser 100 is received in the receiving space 310 and is aimed at the opening 312. The collimator lens 200 seals the opening 312 and collimates the laser beam 110.

The device 10 further includes a worktable 400. The worktable 400 includes a table 410, a mechanical arm 420, and a controller 430. The table 410 supports the sapphire substrate 20. The table 410 defines a slit 412. The sapphire substrate 20 is positioned across the slit 412. The mechanical arm 420 is positioned above the table 410 and can move the shell 300. The collimated laser beam 120 passes through the slit 412. The controller 430 controls the mechanical arm 420 to drive the shell 300 to move such that the collimated moves along a predetermined trajectory and the picoseconds laser 100 is switched on and switched off to cut the sapphire substrate 20 as desired. In this embodiment, the predetermined trajectory coincides with the slit 412 to protect the table 410 from laser damage.

The table 410 also defines a circular hole 414. The circular hole 414 communicates with the slit 412 or in other embodiments is separated from the slit 412. The sapphire substrate 20 can be positioned to cover the circular hole. The predetermined trajectory can be a circle falling within the circular hole 414. That is, the device 10 can cut a circular piece (not shown) from the sapphire substrate 20 without cutting the table 410.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A device for cutting a sapphire substrate, the device comprising:
a picoseconds laser for emitting a laser beam; and
a collimator lens positioned in a path of the laser beam and for collimating the laser beam to produce a collimated laser beam for cutting.

2. The device of claim 1, wherein a pulse width of the laser beam is shorter than 15 picoseconds.

3. The device of claim 1, wherein the picoseconds laser is selected from the group consisting of an ultrasonic laser, a green laser, and a near-infrared laser.

4. The device of claim 1, wherein a wavelength of the laser beam is selected from the group consisting of 355 nm, 343 nm, 266 nm, 532 nm, 515 nm, 1030 nm, and 1064 nm.

5. The device of claim 1, wherein a repetition frequency of the picoseconds laser is adjustable.

6. The device of claim 1, further comprising a shell, the shell defining a receiving space having an opening, the picoseconds laser being received in the receiving space and aiming at the opening, the collimator lens sealing the opening.

7. The device of claim 6, further comprising a worktable, the worktable comprising:
a table defining a slit, the sapphire substrate being positioned on the table and across the slit;
a mechanical arm arranged above the table and holding the shell, the picoseconds collimated laser beam passing through the slit; and
a controller configured for controlling the mechanical arm to drive the shell to move such that the collimated laser beam moves along a predetermined trajectory that coincides with the slit.

8. The device of claim 7, wherein the table defines a circular hole, the sapphire substrate is positioned to cover the circular hole, and the predetermined trajectory is a circle falling within the circular hole.

9. The device of claim 8, wherein the circular hole communicates with the slit.

10. The device of claim 8, wherein the circular hole is separated from the slit.
